(19) United States
(12) Patent Application Publication
(10) Pub. No.: US 2025/0125709 A1
(43) Pub. Date: Apr. 17, 2025

(54) INTERLEAVED TOTEM-POLE POWER CONVERTER

(71) Applicant: Huawei Digital Power Technologies Co., Ltd., Shenzhen (CN)

(72) Inventors: Carlos Martinez, Kista (SE); Grover Victor Torrico-Bascopé, Kista (SE)

(21) Appl. No.: 18/920,881

(22) Filed: Oct. 19, 2024

Related U.S. Application Data
(63) Continuation of application No. PCT/EP2022/060256, filed on Apr. 19, 2022.

(51) Int. Cl. H02M 1/00; H02M 1/42; H02M 7/5395; H02M 7/797

(52) U.S. Cl. CPC H02M 1/0058; H02M 1/4225; H02M 7/5395; H02M 7/797

(57) ABSTRACT

An interleaved totem-pole power converter (500) includes a direct current, DC, capacitor (502), a pair of low frequency switching devices (504a and 504b) connected in series with each other and in parallel with the DC capacitor and two pairs of high frequency switching devices (506 a, 506b, 506c and 506d) connected in series with each other and in parallel with the DC capacitor (502). The two pairs of high frequency switching devices (506 a, 506b, 506c and 506d) are connected in an interleaving manner to a first output inductor (508a) and a second output inductor (508b) which are connected to an alternating current, AC, capacitor (512), and a resistive load is connected in parallel with the AC capacitor. An auxiliary inductor (510) is connected in between switching legs of the converter (500) with a control system (516,704) configured for regulating a current circulation through the auxiliary inductor (510).

### CROSS-REFERENCE TO RELATED APPLICATIONS

This application is a continuation of International Application No. PCT/EP2022/060256, filed on Apr. 19, 2022, the disclosure of which is hereby incorporated by reference in its entirety.

### TECHNICAL FIELD

The disclosure relates to power converters and, more specifically, an Interleaved Totem-Pole Power Converter.

### BACKGROUND

The developing trend of AC/DC power converters for Power Factor Correction (PFC) applications leads towards higher efficiency and higher power density. Also, a bidirectional behaviour of the converter is also desirable, allowing the converter both to draw and inject power from and to the grid.

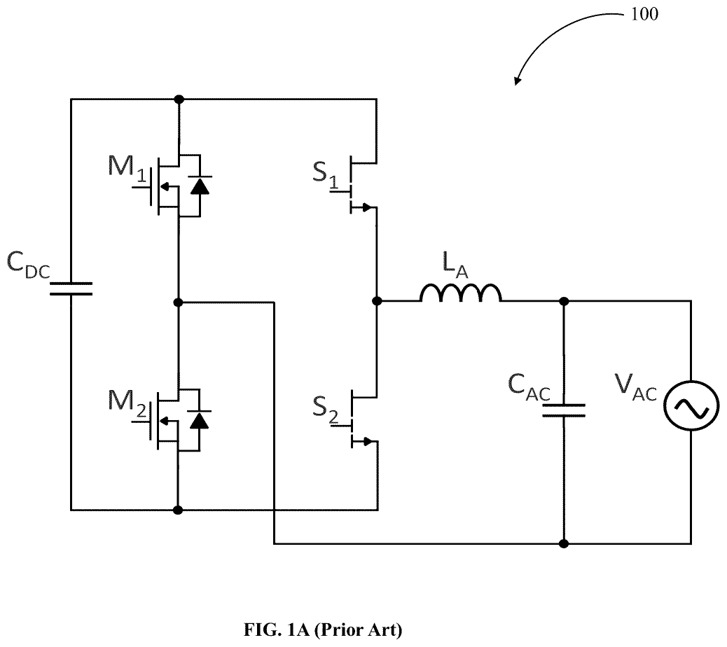

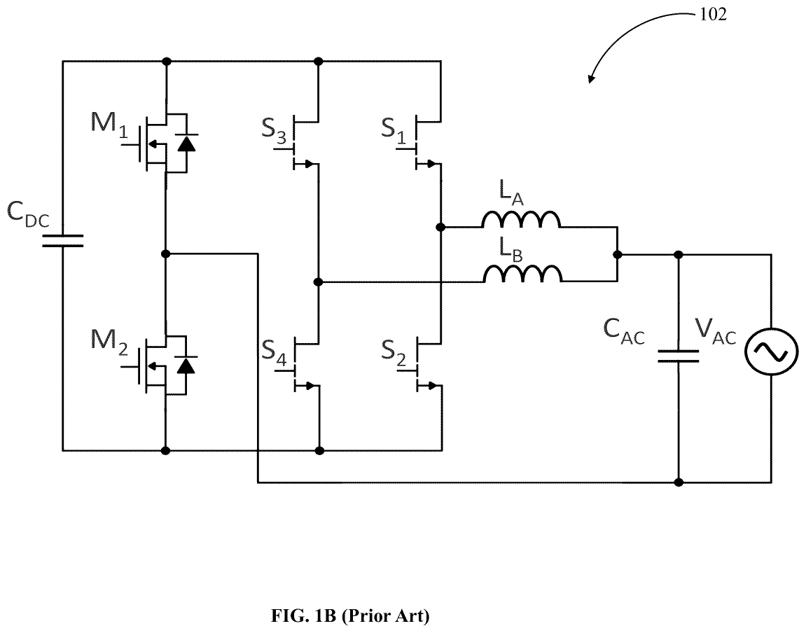

FIGS. 1A-1B illustrate a Non-interleaving and Interleaving bidirectional totem-pole converter, in accordance with a prior art. The most popular AC/DC converter topology in PFC applications is the bridgeless totem-pole converter 100 as shown in FIG. 1a followed by a DC/DC stage. The totem-pole converter can be operated in different modes depending on the current ripple allowed on the input inductor. The topology depicted in FIG. 1a with MOSFET devices in the low frequency leg and GaN devices in the high frequency leg has a bidirectional power transfer capability, meaning that it may be operated as a rectifier (PFC) or as an inverter.

Generally, for high power applications, Continuous Conduction Mode (CCM) operation is desired, because it can guarantee a small ripple on the input inductor current and hence, lessens conduction losses. Furthermore, the topology as shown in FIG. 1b can be interleaved, to form an Interleaved Totem-pole converter 102 as shown in FIG. 1b, to reduce the current ripple across the input inductor and therefore to reduce the footprint of such. Moreover, Zero Voltage Switching (ZVS) is gaining attention since it reduces switching losses in the converter and it also allows the converter to operate at much higher frequencies without a temperature limitation.

However, one main drawback of the CCM control of the totem-pole converter is the fact that ZVS is not naturally achieved under CCM modulation, which limits the frequency operation scope.

Different solutions are proposed to achieve ZVS in a CCM totem-pole converter. However, one of the challenges is guaranteeing ZVS operation in a CCM totem-pole converter. In order to do so, the conventional methods have made modifications to the hardware, where additional active circuits have been added to the CCM totem-pole converter to produce ZVS. The main limitations of such active circuits are the use of additional semiconductor devices as well as magnetic components, which increase losses and complexity.

A simpler approach to achieve ZVS without the use of an active auxiliary circuit is by adding an inductor in between the switching legs of the interleaved converter. In a first method, ZVS is achieved as long as the switches operate with a higher duty ratio of 0.5, which cannot be guaranteed in most PFC applications. According to a second method, a frequency control methodology is used, which varies the frequency when the duty cycle is less than 0.5 in order to maximize the ZVS circulating current in that area and thus improve the overall efficiency. However, this methodology fails to consider the effect of the variable frequency on the required ZVS current. The third method, seeks to optimize the current circulation through the additional inductor but by means of controlling the phase-shift between the two interleaving legs.

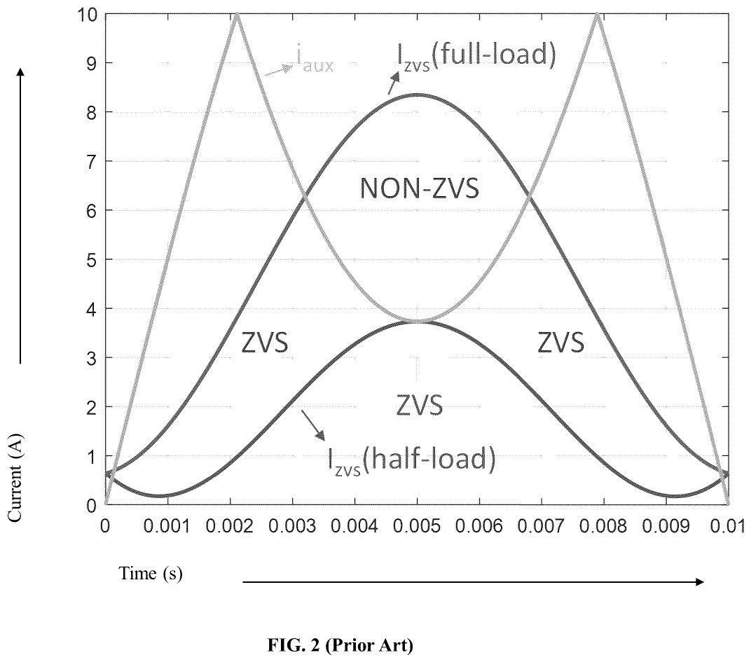

FIG. 2 is a graph illustrating an auxiliary inductor current and ZVS required current for different load conditions with fixed switching frequency, according to a prior art. If the converter is operated with fixed frequency, the circulating current through the auxiliary inductor (i_{AUX}) will have the shape as shown in FIG. 2. If a comparison is established between the produced reactive current by the auxiliary inductor (i_{AUX}) and the required ZVS current (i_{ZVS}) for a certain load condition the following observations can be made. i_{AUX} does not have the same wave shape as i_{ZVS} and therefore, ensuring that i_{AUX} is always bigger than i_{ZVS} during the positive and negative semi-cycles would mean that an excessive amount of current would be used except for the point at which i_{ZVS} is maximum. The ZVS current varies with load, which means that the auxiliary current must be sized for the worst-case scenario (full load) which would mean that at lighter loads an excessive amount of reactive current would be circulating through the auxiliary inductor which would translate into losses. It is this clear that the current through the auxiliary inductor must be controlled in order to achieve an optimal performance whilst ensuring ZVS in the high frequency devices.

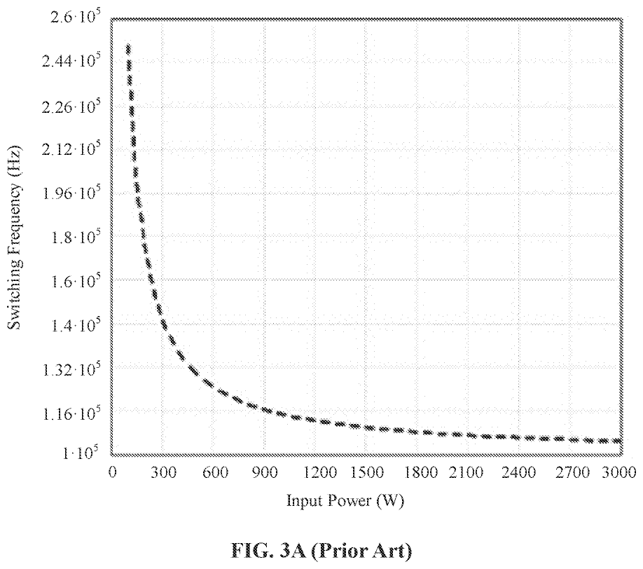

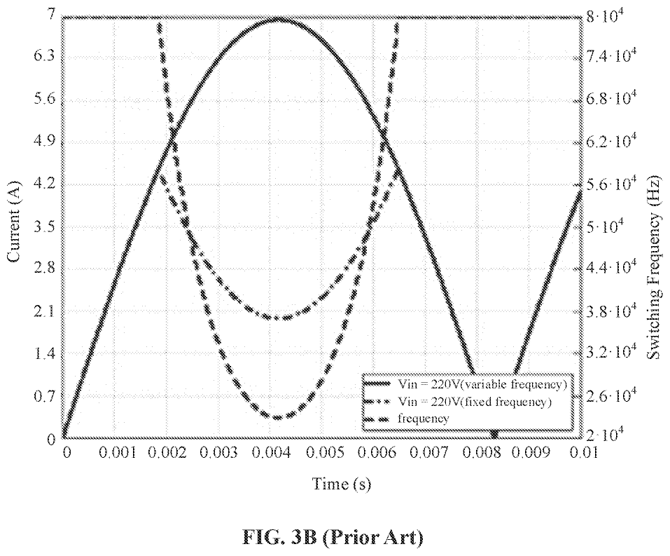

FIG. 3A is a graph illustrating a base switching frequency variation with the load, according to a prior art. The duty-cycle (D) would refer to the inverter operation and is thus defined as:

$$D = \frac{\vert {V}_{c} \vert}{{V}_{D C}}$$

FIG. 3B is a graph illustrating a frequency variation within one semi-cycle and the effect on the auxiliary inductor current, according to a prior art. Such frequency variation can be performed by equation below:

$${f}_{sw \_ variable} = \{ \begin{matrix}\frac{1 - \frac{\vert {V}_{c} \vert}{{V}_{D C}}}{\frac{\vert {V}_{c} \vert}{{V}_{D C}}} {f}_{sw} , for D > 0.5 \\ {f}_{sw} , for D < 0.5\end{matrix}$$

This wave-shaping control however, fails to consider the effect of the frequency variation on the required ZVS. It should be noted that both the auxiliary inductor current and the required ZVS current are frequency dependent, according to the equations shown below:

$${i}_{A U X} = \{ \begin{matrix}\frac{{V}_{D C} - \vert {V}_{c} \vert}{2 {L}_{AUX} {f}_{s}} , for D > 0.5 \\ \frac{\vert {V}_{c} \vert}{2 {L}_{AUX} {f}_{s}} , for D < 0.5\end{matrix}$$

$${i}_{Z V S} = \vert {i}_{{L}_{A}} \vert - \frac{\vert {V}_{c} \vert ( 1 - \frac{\vert {V}_{c} \vert}{{V}_{D C}} )}{2 {f}_{s} {L}_{A}} + \frac{2 {C}_{o s s} {V}_{D C}}{{t}_{d}}$$

Where, Cₒₛₛ is the output capacitance of the high frequency switch, ta is the dead time between the upper and lower switches and fs is the switching frequency.

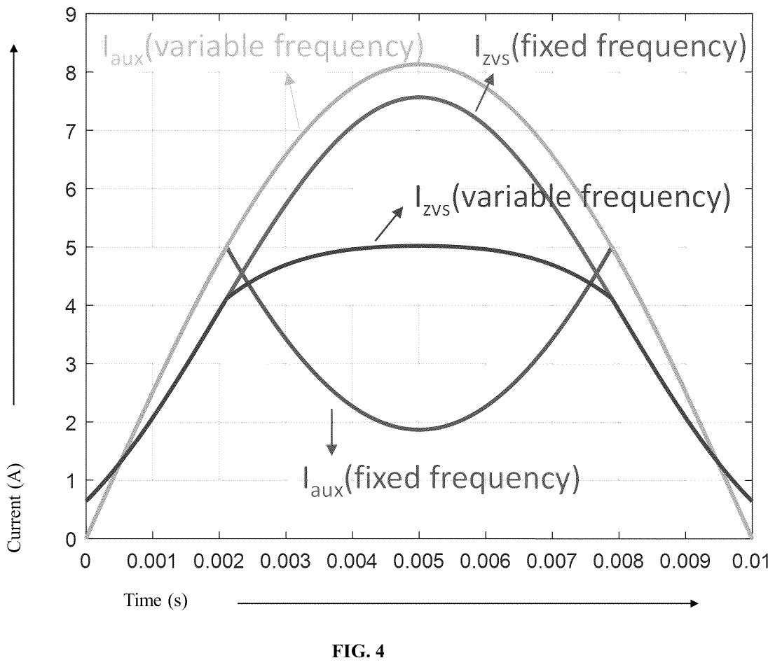

FIG. 4 is a graphical representation of effect of frequency variation modulation over the required ZVS current, according to a prior art. By changing the frequency over one semi-cycle to make the auxiliary inductor greater than the required ZVS current, affects the value and shape of the required ZVS current. As illustrated in FIG. 4, the frequency variation to achieve ZVS has been applied to the inverter totem-pole converter. It can be observed how i_{AUX} is reshaped to follow the ZVS current pattern, and by doing so the peak value and shape of the ZVS required currents is now changed. Therefore, it can be concluded that the variable frequency modulation control strategy according to the existing technologies, ensures ZVS operation and a better utilization of the auxiliary inductor current. However, it is not the most optimal solution to ensure ZVS with the minimum amount of reactive current circulation. This is because the frequency variation modulation affects the required ZVS current as shown in FIG. 4. Here the new auxiliary inductor current is shaped to be higher than the initial required ZVS current, however, due to this dependence on the frequency, the resulting required ZVS current will be even lower when the frequency variation modulation is applied. Therefore, the frequency variation modulation methodology using additional components does not provide the minimum ZVS current circulation.

Also, the totem-pole circuit is well explored working as an AC/DC PFC bridgeless boost converter with ZVS characteristics. However, the existing methods and systems does not address the DC/AC functionality with ZVS characteristics i.e., the totem-pole circuit as a CCM inverter.

Therefore, there arises a need to address the aforementioned technical drawbacks in known techniques in CCM control of the interleaved totem-pole converter to achieve ZVS without the use of an auxiliary circuit.

### SUMMARY

It is an object of the disclosure to provide a solution to achieve optimal ZVS in a CCM totem-pole inverter (DC/AC) by using a single additional magnetic component (auxiliary inductor) while avoiding one or more disadvantages of prior art approaches.

It is another object of the disclosure to provide an optimized frequency variation modulation control strategy to ensure ZVS with the minimum required reactive current circulation.

It is yet another object of the disclosure to improve high efficiency and high-power density in totem-pole converter.

These objects are achieved by the features of the independent claims. Further, implementation forms are apparent from the dependent claims, the description, and the figures.

According to a first aspect, an interleaved totem-pole power converter is provided. The interleaved totem-pole power converter includes a direct current, DC, capacitor on an input side, a pair of low frequency switching devices, two pairs of high frequency switching devices, a resistive load, and a control system. The pair of low frequency switching devices connected in series with each other and in parallel with the DC capacitor. The two pairs of high frequency switching devices, each pair of the high frequency switching devices being connected in series with each other and in parallel with the DC capacitor. The two pairs of high frequency switching devices are connected in an interleaving manner to a first output inductor and a second output inductor. The first output inductor and the second output inductor are connected in parallel with a joint output being connected to an alternating current, AC, capacitor on an output side. The resistive load connected in parallel with the AC capacitor. The auxiliary inductor connected in between switching legs of the converter formed by the pairs of high frequency switching devices. The control system configured for regulating a current circulation through the auxiliary inductor to ensure zero voltage switching, ZVS, in the high frequency switching devices by changing a switching frequency of the high frequency switching devices at each switching instant whilst maintaining a sinusoidal output voltage at output terminals of the converter regardless of a connected load type.

Thus, the frequency control methodology used by the interleaved totem-pole converter with the auxiliary inductor is suitable for both rectifier mode AC/DC and inverter mode DC/AC guaranteeing the bidirectional operation of the converter. The variable frequency control modulation herein changes the switching frequency of the converter at every single switching period to produce the necessary current through the auxiliary inductor which will ensure ZVS in the high frequency switches. This enables the regulation of the auxiliary inductor current so that the current level is always higher than the required current to achieve ZVS at any switching instant. The more switching frequency control results in less reactive current circulation and increased efficiency.

In an implementation, the interleaved totem-pole power converter includes a pulse width modulation, PWM, modulator coupled with the control system and the high frequency switching devices. The control system is configured for implementing a cascaded closed loop control that includes an inner current control loop and an outer voltage control loop for regulating the voltage across a load providing a target output voltage based on values of voltage and current read from analog to digital conversion ports. The read values include values of voltage and current on the AC capacitor and a value of current on the joint output. The interleaved totem-pole power converter calculates the switching frequency based on the read values and a value of voltage on the DC capacitor. The PWM modulator is configured for generating modulated switching signals for the high frequency switching devices based on the target output voltage and the switching frequency.

In an implementation, the control system is configured for calculating the switching frequency by means of calculating a base switching frequency depending on a load of the converter, and varying the base switching frequency over each half semi-cycle of the converter to provide the current circulating through the auxiliary inductor of the same shape as a current required for the ZVS that is frequency dependent.

In an implementation, the control system is configured for calculating the switching frequency to provide the current circulating through the auxiliary inductor greater than current required for the ZVS by a pre-defined safety margin.

In an implementation, the control system is configured for implementing the cascaded closed loop control in a limited frequency band defined by an upper switching frequency threshold and a lower upper switching frequency threshold.

In an implementation, the control system includes a programed micro controller unit, MCU.

In an implementation, the converter is configured for operating in both a rectifier mode converting AC to DC and an inverter mode converting DC to AC.

A technical problem in the prior art is resolved, where the technical problem concerns an optimizing frequency variation modulation control to ensure ZVS with the minimum required reactive current circulation.

Therefore, in contradistinction to the prior art, the present disclosure employs an interleaved totem pole converter with an auxiliary inductor and a frequency variation modulation control strategy to regulate the current circulation through the auxiliary inductor. The ZVS CCM with only one additional inductor unlike previous solutions which require additional circuitry, ensures the minimal utilization of reactive current to achieve ZVS. Furthermore, the frequency variation is less, which means a reduced ripple in the boost inductor. Furthermore, the interleaving nature of the topology is retained by keeping the 180 degrees phase-shift. Moreover, no additional sensing is required for the calculation of the switching frequency as all the variables needed in the calculation are known (V_{AC}, i_{L}, V_{DC}). The more accurate switching frequency control thus results in less reactive current circulation and increased efficiency.

These and other aspects of the disclosure will be apparent from and the implementation(s) described below.

### BRIEF DESCRIPTION OF DRA WINGS

Implementations of the disclosure will now be described, by way of example only, with reference to the accompanying drawings, in which:

FIGS. 1A-1B illustrate a Non-interleaving and an Interleaving bidirectional totem-pole converter, in accordance with a prior art;

FIG. 2 is a graph illustrating an auxiliary inductor current and ZVS required current for different load conditions with fixed switching frequency, according to a prior art;

FIG. 3A is a graph illustrating a base switching frequency variation with the load, according to a prior art;

FIG. 3B is a graph illustrating a frequency variation within one semi-cycle and the effect on the auxiliary inductor current, according to a prior art.

FIG. 4 is a graphical representation of effect of the frequency variation modulation over the required ZVS current, according to a prior art;

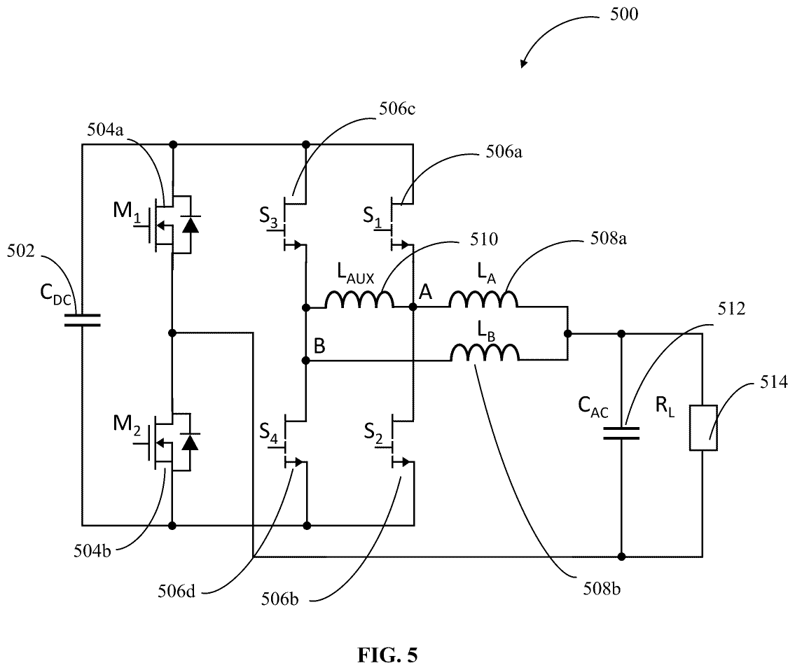

FIG. 5 is a circuit diagram of a Bidirectional interleaved totem-pole AC/DC converter with an auxiliary inductor, in accordance with an implementation of the disclosure;

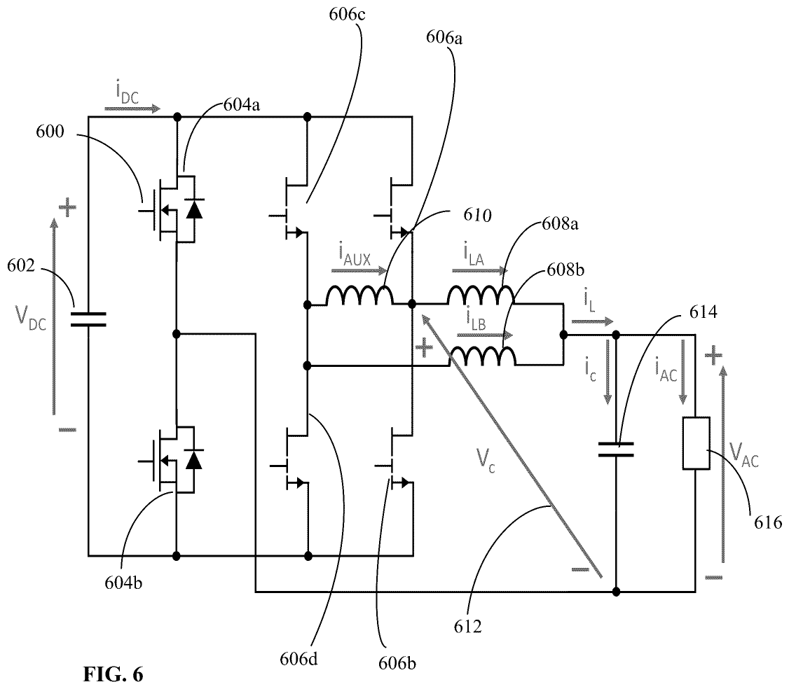

FIG. 6 is a topological diagram of a Bidirectional interleaved totem-pole AC/DC converter illustrating a voltage current signing, in accordance with an implementation of the disclosure;

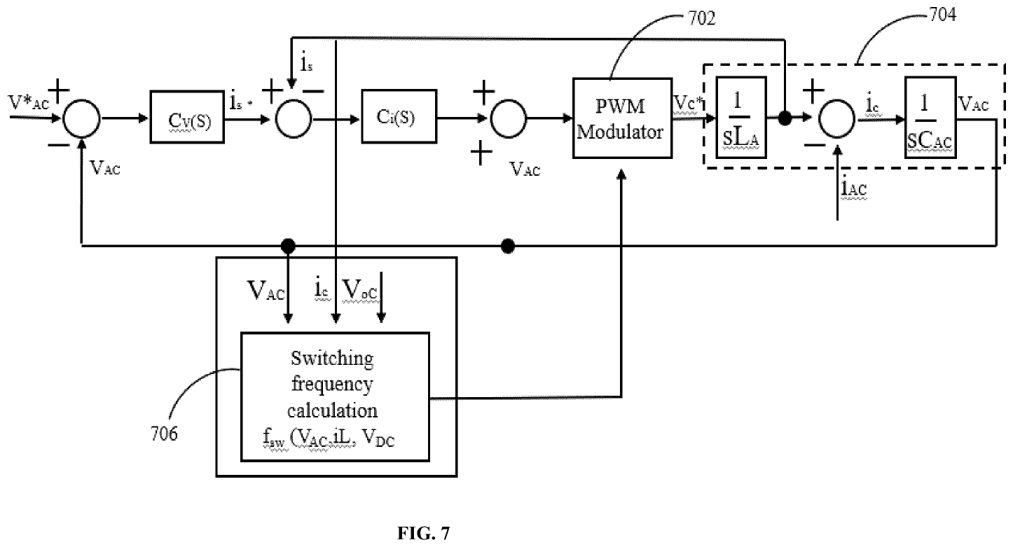

FIG. 7 is a block diagram of a control system of a Bidirectional interleaved totem-pole AC/DC converter, in accordance with an implementation of the disclosure;

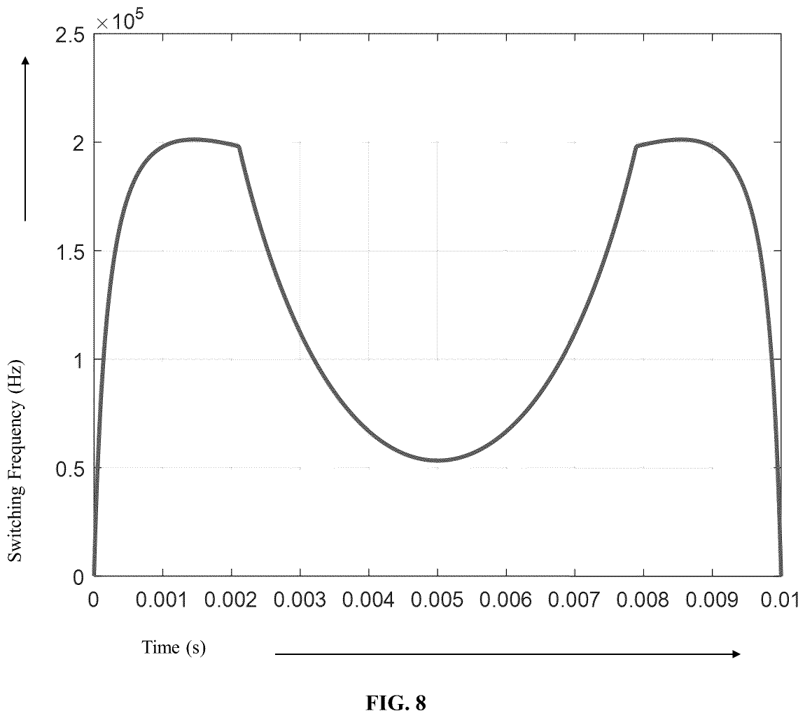

FIG. 8 is a graphical representation of variation of the switching frequency over one semi-cycle, in accordance with an implementation of the disclosure;

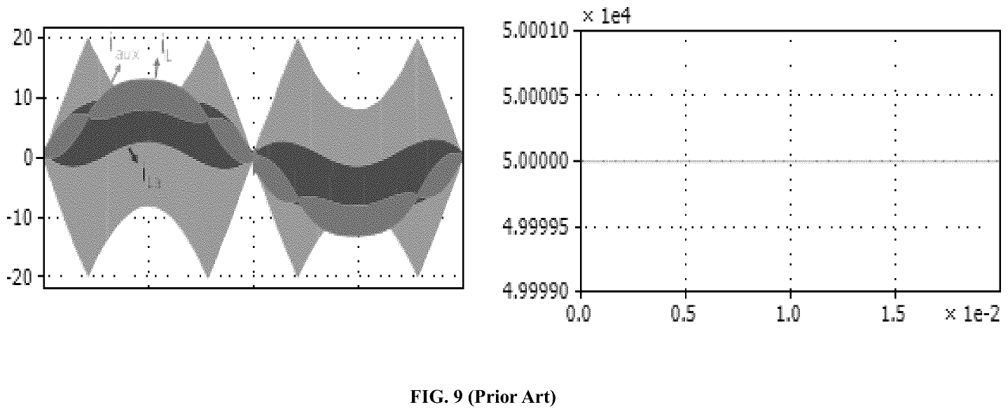

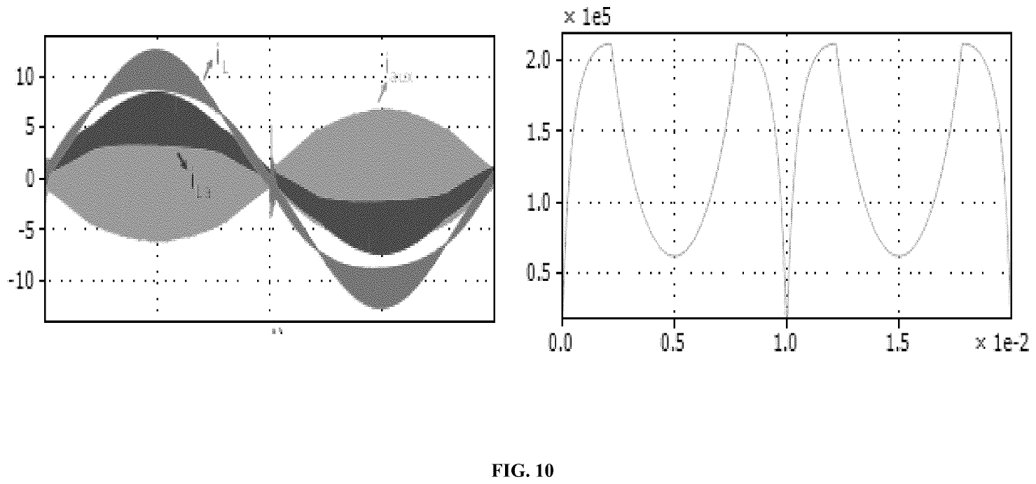

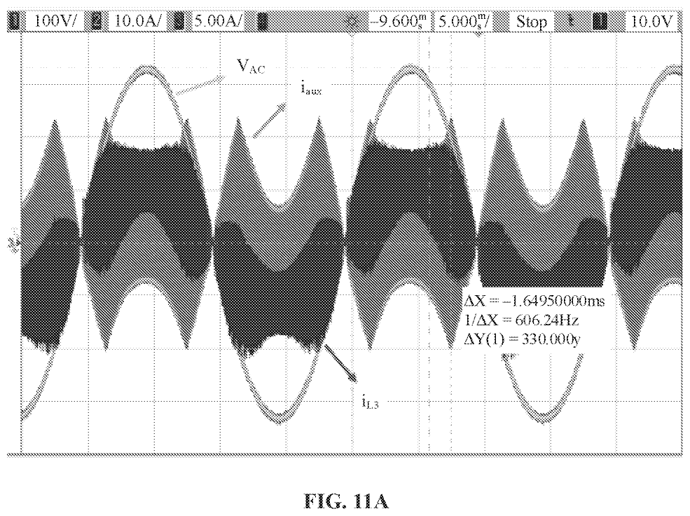

FIGS. 9 and 10 are graphs illustrating a comparison of a variable frequency control in accordance with an implementation of the disclosure (FIG. 10) with a fixed frequency control in accordance with a prior art (FIG. 9);

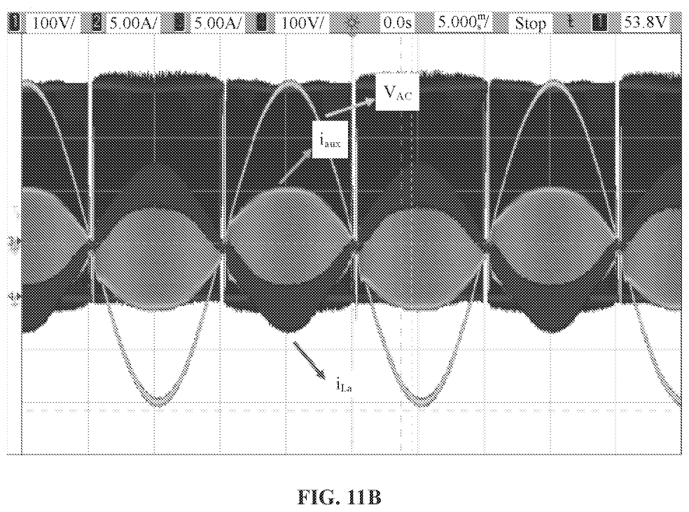

FIGS. 11A-11B are example illustration of experimental validation of the variable frequency modulation control in accordance with an implementation of the disclosure (FIG. 11B), in comparison to a fixed frequency control in accordance with a prior art (FIG. 11A); and

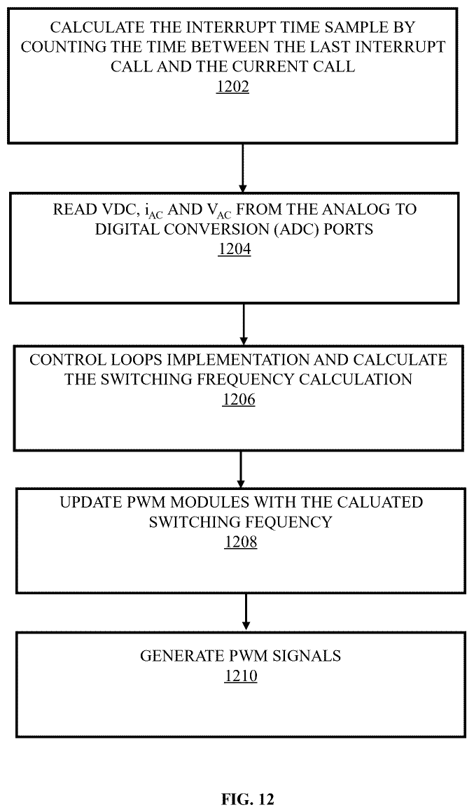

FIG. 12 is a flow chart illustrating a process of variable frequency calculation executed by the control system of FIG. 7, in accordance with an implementation of the disclosure.

### DETAILED DESCRIPTION OF THE DRAWINGS

Implementations of the disclosure provide a Bidirectional interleaved totem-pole AC/DC converter with an auxiliary inductor, which is able to provide more accurate switching frequency control which results in less reactive current circulation and increased efficiency.

To make solutions of the disclosure more comprehensible for a person skilled in the art, the following implementations of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

The variable frequency modulation control methodology according to the disclosure herein, controls the current through the auxiliary inductor in order to achieve an optimal performance and also ensure ZVS in high frequency devices. This optimization is achieved by first calculating a base frequency which would vary with the load (f_{sw}), and secondly by varying the frequency over each half semi-cycle in such a way that the auxiliary current would be shaped in a sinusoidal manner, following the shape of the required ZVS current.

FIG. 5 is a circuit diagram of a Bidirectional interleaved totem-pole AC/DC converter 500 with an auxiliary inductor, in accordance with an implementation of the disclosure. The interleaved totem-pole power converter 500 includes a direct current (DC) capacitor 502 on an input side, a pair of low frequency MOSFET switching devices M₁ 504a and M₂ 504b, two pairs of high frequency switching devices (S₁-S₄) 506 a, 506b, 506c and 506d a first output inductor (L_{A}) 508a, a second output inductor (L_{B}) 508b, an auxiliary inductor (L_{AUX}) 510, an alternating current output capacitor (C_{AC}) 512, a resistive load (R_{L}) 514 and a control system 516. The pair of low frequency MOSFET switching devices M₁ 504a and M₂ 504b connected in series with each other and in parallel with the DC capacitor 502, Each pair of the high frequency switching devices (S₁-S₄) 506 a, 506b, 506c and 506d being connected in series with each other and in parallel with the DC capacitor 502. The two pairs of high frequency switching devices (S₁-S₄) 506 a, 506b, 506c and 506d are connected in an interleaving manner to the first output inductor (L_{A}) 508a and the second output inductor (L_{B}) 508b. The first output inductor (L_{A}) 508a and the second output inductor (L_{B}) 508b are connected in parallel with a joint output being connected to the alternating current, AC, capacitor (C_{AC}) 512 on an output side. The resistive load (R_{L}) 514 is connected in parallel with the AC capacitor (C_{AC}) 512. The auxiliary inductor 510 is connected in between switching legs of the converter formed by the pairs of high frequency switching devices (S₁-S₄) 506 a, 506b, 506c and 506d. The control system 516 is configured for regulating a current circulation through the auxiliary inductor 510 to ensure zero voltage switching, ZVS, in the high frequency switching devices by changing the switching frequency of the high frequency switching devices (S₁-S₄) 506 a, 506b, 506c and 506d at each switching instant whilst maintaining a sinusoidal output voltage at output terminals of the converter regardless of a connected load type.

Thus, the frequency control methodology used by the interleaved totem-pole converter 500 with the auxiliary inductor 510 is suitable for both rectifier mode AC/DC and inverter mode DC/AC guaranteeing the bidirectional operation of the converter 500. The variable frequency control modulation herein changes the switching frequency of the converter 500 at every single switching period to produce the necessary current through the auxiliary inductor 510 which will ensure ZVS in the high frequency switches. This enables the regulation of the auxiliary inductor current so that the current level is always higher than the required current to achieve ZVS at any switching instant. The more switching frequency control results in less reactive current circulation and increased efficiency.

In an implementation, the control system calculates the switching frequency by means of calculating a base switching frequency depending on a load of the converter 500 and varies the base switching frequency over each half semi-cycle of the converter 500 to provide the current circulating through the auxiliary inductor 510 of the same shape as the current required for the ZVS that is frequency dependent.

In an implementation, the control system calculates the switching frequency to provide the current circulating through the auxiliary inductor 510 greater than current required for the ZVS by a pre-defined safety margin.

In an implementation, the control system is configured for implementing the cascaded closed loop control in a limited frequency band defined by an upper switching frequency threshold and a lower upper switching frequency threshold.

In an implementation, the control system includes a programed micro controller unit, MCU. Optionally, the converter 500 is configured for operating in both a rectifier mode converting AC to DC and an inverter mode converting DC to AC.

Thus, interleaved totem pole converter 500 with an auxiliary inductor 510 herein achieves ZVS using a frequency control methodology which changes the switching frequency of the converter 500 at every single switching period to produce the necessary current through the auxiliary inductor, thereby ensuring ZVS in the high frequency switches. The circulating current through the auxiliary inductor 510 which is shaped by the frequency variation ensures ZVS with the minimum reactive current circulation. Further, the cascaded closed loop control which include an inner current control loop and an outer voltage control loop, regulates the output voltage across the load for standalone inverter operation. The output of the cascaded controller will be modulated using the calculated switching frequency.

FIG. 6 is a topological diagram of a Bidirectional interleaved totem-pole AC/DC converter illustrating a voltage current signing, in accordance with an implementation of the disclosure. The topological circuit is formed by a DC capacitor (C_{DC}) on the input side 602, a pair of low frequency (50 Hz) MOSFET switching devices (M₁ and M₂) 604a-604b, two pairs of GaN high frequency (kHz) switching devices (S₁, S₂ and S₃, S₄) 606a-606d, connected in an interleaving manner to their respective output inductors (L_{A} and L_{B}) 608a-608b. In between the switching nodes (A and B) 612, the auxiliary inductor (L_{AUX}) 610 is placed to achieve ZVS. The output inductors (i_{LA} and i_{LB}) 608a-608b are connected in parallel, and their joint output is connected to the output capacitor (C_{AC}) 614. The resistive load (R_{L}) 616 is connected in parallel with the output capacitor (C_{AC}) 610.

The sign convention is depicted in FIG. 6, in which the power is considered positive going from the DC to the AC side.

FIG. 7 is a block diagram of a control system 704 of a Bidirectional interleaved totem-pole AC/DC converter, in accordance with an implementation of the disclosure.

The pulse width modulation (PWM) modulator 702 is coupled with the control system 704 and the high frequency switching devices (S₁-S₄) as shown in FIG. 7. The control system 704 is configured for implementing a cascaded closed loop control that includes an inner current control loop and an outer voltage control loop for regulating voltage across resistive load (R_{L}) of the converter to provide a target output voltage based on the voltage and current values read from analog to digital conversion ports. The values comprising voltage value on the AC capacitor and current value on the joint output are used to calculate the switching frequency.

The PWM modulator 702 is configured for generating modulated switching signals for the high frequency switching devices based on the calculated target output voltage and the switching frequency.

According to the embodiments herein, a cascaded loop is implemented to optimal operation of the PWM modulator 702 in both inverter and rectifier modes. The overall control loop as shown in in FIG. 7 includes an outer voltage control loop and an inner current control loop. The output of the inner current control loop is generated by modulating the DSP reference signal using pulse width modulation (PWM), is the converter voltage The PWM modulation creates switching signals to the GaN switches (S₁-S₄). At the same time, the switching frequency is calculated at every switching instant and is used to generate the carrier signals in the PWM modulator. The switching frequency calculation is performed using the below equation and it is not enforced by any control loop (open loop).

$${f}_{sw \_ variable} = \{ \begin{matrix}\frac{\vert {V}_{c} \vert ( 1 - \frac{\vert {V}_{c} \vert}{{V}_{D C}} ) + \frac{{V}_{D C} ( 1 - \frac{\vert {V}_{c} \vert}{{V}_{D C}} ) {L}_{A}}{{L}_{AUX}}}{2 {L}_{A} ( \vert {i}_{{L}_{A}} \vert + k )} , for D > 0.5 \\ \frac{\vert {V}_{c} \vert ( 1 - \frac{\vert {V}_{c} \vert}{{V}_{D C}} ) + \frac{\vert {V}_{c} \vert {L}_{A}}{{L}_{AUX}}}{2 {L}_{A} ( \vert {i}_{{L}_{A}} \vert + k )} , for D < 0.5\end{matrix}$$

To avoid undesirable converter operation due to the switching frequency variation, the switching frequency is limited to an upper and lower threshold (depending on the application). The control of the converter is digitally implemented. The control loops and the frequency calculation is programed into a Micro Controller Unit (MCU) 706.

FIG. 8 is a graphical representation of variation of the switching frequency modulation over one semi-cycle, in accordance with an implementation of the disclosure. The switching frequency reaches zero when the converter duty cycle (D) equals zero. The minimum switching frequency must be limited to ensure the correct operation of the converter.

Here the switching frequency is calculated, which would make:

$${i}_{A U X} = {i}_{Z V S} + safety\_margin$$

Further, the switching frequency can be expressed as:

$${f}_{sw \_ variable} = \{ \begin{matrix}\frac{\vert {V}_{c} \vert ( 1 - \frac{\vert {V}_{c} \vert}{{V}_{D C}} ) + \frac{{V}_{D C} ( 1 - \frac{\vert {V}_{c} \vert}{{V}_{D C}} ) {L}_{A}}{{L}_{AUX}}}{2 {L}_{A} ( \vert {i}_{{L}_{A}} \vert + k )} , for D > 0.5 \\ \frac{\vert {V}_{c} \vert ( 1 - \frac{\vert {V}_{c} \vert}{{V}_{D C}} ) + \frac{\vert {V}_{c} \vert {L}_{A}}{{L}_{AUX}}}{2 {L}_{A} ( \vert {i}_{{L}_{A}} \vert + k )} , for D < 0.5\end{matrix}$$

Where k can be defined as:

$$k = \frac{2 {C}_{o s s} {V}_{D C}}{{t}_{d}} + safety\_margin$$

FIGS. 9 and 10 are graphs illustrating a comparison of a variable frequency control in accordance with an implementation of the disclosure (FIG. 10) with a fixed frequency control in accordance with a prior art (FIG. 9).

The effectiveness of the frequency variation control has been validated first in simulation and experimentally afterwards. The simulation results of the frequency modulation control are as shown in FIG. 10, by comparing them with the results obtained by maintaining the frequency constant as shown in FIG. 9. As shown in FIG. 10, the switching frequency has been selected to be 50 kHz which ensures that the current through the auxiliary inductor is always higher than the required ZVS current. Thus, by keeping the frequency fixed, there is an over-circulation of current through the auxiliary inductor during certain periods across the 100 Hz cycle which will translate into losses, as shown in FIG. 9. This problem is mitigated by implementing the frequency modulation control methodology according to the present disclosure. As it is illustrated in FIG. 10, less reactive current is used to achieve ZVS based on the frequency variation.

As the valley current of the output inductor varies with the switching frequency, the required ZVS current also varies. Accordingly, the frequency variation modulation control herein will adapt to the auxiliary inductor current to follow the required ZVS current shape.

FIGS. 11A-11B is an example illustration of the validation of the variable frequency modulation control, in accordance with an implementation of the disclosure. FIGS. 11A-11B illustrate the plotting of converter AC voltage (V_{AC}), the inductor current (I_{L}), the auxiliary inductor current (I_{AUX}). Here, FIG. 11A corresponds to fixed frequency operation, in accordance with the prior art and FIG. 11B corresponds to the variable frequency modulation operation according to the disclosure herein. The results of the frequency variation modulation control of the present disclosure is compared to the frequency variables obtained with fixed frequency according to the existing art.

FIG. 12 is a flow chart illustrating a process of variable frequency calculation in a Bidirectional interleaved totem-pole AC/DC converter, in accordance with an implementation of the disclosure. The control of the Bidirectional interleaved totem-pole AC/DC of the converter herein is digitally implemented. The control loops and the frequency calculation are programmed into a micro controller unit (MCU) to perform the following steps. At 1202, the interrupt sample time is calculated by counting the time between the last interrupt call and the current call. This interrupt sample time is then used in the calculation of the reference output voltage (V_{AC}*). At 1204, the variables such as V_{DC}, i_{AC} and V_{AC} are obtained from the analog to digital conversion (ADC) ports. At step 1206, the cascaded control loops are implemented and the switching frequency is calculated based on the obtained variables V_{DC}, i_{AC} and V_{AC}. Once the target output voltage (Vc*) and the new switching frequency are calculated, at step 1208, the PWM module is updated with the calculated switching frequency. Further at step 1210, the PWM signals are generated and inputted to the PWM modulator.

The disclosure herein discloses a variable frequency modulation control strategy for an interleaved totem-pole converter with an auxiliary inductor, where the frequency modulation control is suitable for both rectifier mode AC/DC and inverter mode DC/AC guaranteeing the bidirectional operation of the converter. This frequency control modulation enables the regulation of the auxiliary inductor current so that the inductor current is always higher than the required current to achieve ZVS at any switching instant.

In another aspect, one or more different types of recovery auxiliary circuits (either active or passive) is used for achieving ZVS in the high frequency switches along with the appropriate control strategy.

The disclosure herein uses an interleaved totem pole converter with an auxiliary inductor and a frequency variation modulation control technology to regulate the current circulation through the auxiliary inductor. The ZVS CCM solution of the disclosure uses one additional inductor thereby does not require any additional circuitry. Further, only minimal reactive current is utilized to achieve ZVS. The frequency variation is less as compared to the existing solutions, which refers to a reduced ripple in the boost inductor. The interleaving nature of the converter topology is kept at a 180 degrees phase-shift. No additional sensing is required for the calculation of the switching frequency as it automatically reads the variables V_{AC}, i_{L}, V_{DC} required for calculation of the switching frequency.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

What is claimed is:

1. An interleaved totem-pole power converter (500), comprising:
a direct current, DC, capacitor (502) on an input side,
a pair of low frequency switching devices (504a, 504b) connected in series with each other and in parallel with the DC capacitor (502),
two pairs of high frequency switching devices (506a, 506b, 506c, 506d) each pair of the high frequency switching devices (506a, 506b, 506c, 506d) being connected in series with each other and in parallel with the DC capacitor (502),
wherein the two pairs of high frequency switching devices (506a, 506b, 506c, 506d) are connected in an interleaving manner to a first output inductor and a second output inductor,
wherein the first output inductor (508a) and the second output inductor (508b) are connected in parallel with a joint output being connected to an alternating current, AC, capacitor on an output side (512),
a resistive load (514) connected in parallel with the AC capacitor (512),
an auxiliary inductor (510) connected in between switching legs of the converter (500) formed by the pairs of high frequency switching devices (506a, 506b, 506c, 506d), and
a control system (516) configured for regulating a current circulation through the auxiliary inductor (510) to ensure zero voltage switching, ZVS, in the high frequency switching devices (506a, 506b, 506c, 506d) by changing a switching frequency of the high frequency switching devices (506a, 506b, 506c, 506d) at each switching instant whilst maintaining a sinusoidal output voltage at output terminals of the converter (500) regardless of a connected load type.

2. The interleaved totem-pole power converter (500) according to claim 1, comprising a pulse width modulation, PWM, modulator (702) coupled with the control system (516, 704) and the high frequency switching devices (506a, 506b, 506c, 506d),
wherein the control system (516,704) is configured for:
implementing a cascaded closed loop control comprising an inner current control loop and an outer voltage control loop for regulating voltage across a load of the converter (500) to provide a target output voltage based on values of voltage and current read from analog to digital conversion ports, the read values comprising values of voltage and current on the AC capacitor (512) and a value of current on the joint output, and
calculating the switching frequency based on the read values and a value of voltage on the DC capacitor (502),
wherein the PWM modulator (702) is configured for generating modulated switching signals for the high frequency switching devices (506a, 506b, 506c, 506d) based on the target output voltage and the switching frequency.

3. The interleaved totem-pole power converter (500) according to claim 2, wherein the control system (516, 704) is configured for calculating the switching frequency by means of:
calculating a base switching frequency depending on a load of the converter (500), and
varying the base switching frequency over each half semi-cycle of the converter (500) to provide the current circulating through the auxiliary inductor (510) of the same shape as a current required for the ZVS that is frequency dependent.

4. The interleaved totem-pole power converter (500) according to claim 3, wherein the control system (516, 704) is configured for calculating the switching frequency to provide the current circulating through the auxiliary inductor (510) greater than current required for the ZVS by a pre-defined safety margin.

5. The interleaved totem-pole power converter (500) according to claim 1, wherein the control system (516,704) is configured for implementing the cascaded closed loop control in a limited frequency band defined by an upper switching frequency threshold and a lower upper switching frequency threshold.

6. The interleaved totem-pole power converter (500) according to claim 1, wherein the control system (516, 704) comprises a programed micro controller unit, MCU (706).

7. The interleaved totem-pole power converter (500) according to claim 1, wherein the converter (500) is configured for operating in both a rectifier mode converting AC to DC and an inverter mode converting DC to AC.
